(19) United States
(12) Patent Application Publication
(10) Pub. No.: US 2008/0298341 A1
(43) Pub. Date: Dec. 4, 2008

(54) RADIO COMMUNICATION SYSTEM AND RADIO COMMUNICATION METHOD

(76) Inventors: Ryosuke FUJIWARA, Kodaira (JP); Masayuki Miyazaki, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/128,351

(22) Filed: May 28, 2008

(30) Foreign Application Priority Data
May 30, 2007 (JP) JP2007-142779

(51) Int. Cl. H04J 3/06

(52) U.S. Cl. 370/350

(57) ABSTRACT

A radio communication system having an interference reduction function and enabling random access is constructed without complicating a terminal structure. A base station has an interference signal detection function, performs interference signal detection intermittently and transmits a beacon signal when no interference signal is detected. A terminal starts up from a sleep mode before transmitting data, performs reception waiting, transmits data only immediately after reception of the beacon signal, transits to the sleep mode again if the beacon signal is not received and repeats the abovementioned sequence after a predetermined time elapses.

### CROSS-REFERENCE TO RELATED APPLICATION

The present application claims priority from Japanese Patent Application No. JP 2007-142779 filed on May 30, 2007, the content of which is hereby incorporated by reference into this application.

### TECHNICAL FIELD OF THE INVENTION

The present invention relates to a radio communication system technique for performing efficient radio communication between a radio communication base station and a plurality of radio communication terminals.

### BACKGROUND OF THE INVENTION

Conventionally, a method of avoiding implementation of DAA to a terminal by notifying a result of interference detection from a radio device provided with interference signal detection to a terminal not provided with the interference signal detection has been proposed (see Bin Zhen, “DAA framework for UWB”, in IEEE 15-06-00133-00-004a, March, 2006 (Non-Patent Document 1), for example).

And, conventionally, a systems in which a base station notifies an interference signal level and assigns a frequency channel for communication to a mobile terminal has been proposed (see Japanese Patent Application Laid-Open Publication No. 11-136743 (Patent Document 1)).

In a radio network structure composed of a mobile terminal and a base station, such as a sensor network in which sensing data collected at a plurality of terminals having sensors is transmitted to a base station through radio communication, the mobile terminals are required to be battery-operated, and generally required to be low power consumption.

As examples of a radio access control system used in such a network, there are an ALOHA system, a CSMA (Carrier Sense Multiple Access) system and a TDMA (Time Division Multiple Access) system. The ALOHA system and the CSMA system are basically terminal-initiated access control systems. Data transmission is performed by time control at a terminal side, and a load on the terminal can be generally reduced. On the other hand, the TDMA system is base station-initiated access control in which the terminal receives a signal called a beacon from the base station and a timing of data transmission is determined based on the signal. In this system, since the terminal must wait for the beacon signal always, the load on the terminal is relatively large.

On the other hand, in recent years, because of exhaustion of frequency resources, improvement of frequency utilization efficiency is required and an interference reduction technique enabling sharing of the same frequency band among a plurality of radio systems is demanded. This is an essential technique for a radio system using a wide frequency band, such as UWB (Ultra-Wideband), to coexist with other radio systems. As the interference reduction technique, DAA (Detect And Avoid) and LDC (Low Duty Cycle) are known.

The LDC, one of interference reduction functions described above, is a technique reducing influence on other systems by decreasing a transmission ratio of packets. However, in the LDC, a throughput of the whole system is restricted. Therefore, in application handling a large number of terminals and a large amount of data, it is difficult to apply the LDC to the radio system.

On the other hand, the DAA is a technique in which signals from other radio systems (hereinafter referred to as “interference signals”) are monitored and if the interference signals are detected, data is not transmitted or a band of the detection is avoided to transmit the data. A problem of the DAA exists in an interference signal detector detecting an interference signal. In order to operate an interference reduction function effectively, it is necessary to scan for the interference signals over a wide band, and sensitivity thereof must be higher than general sensitivity of a terminal in a radio system generating the interference signal. Therefore, a structure thereof becomes complex and a problem of large power consumption occurs. Accordingly, implementation of the DAA technique to the terminal results in higher cost of terminal and shorter battery life.

Therefore, a method of avoiding the implementation of the DAA to the terminal by notifying a result of the interference detection from a radio device provided with the interference signal detection to a terminal not provided with the interference signal detection is disclosed in Non-Patent Document 1.

And, a system in which a base station notifies an interference signal level and assigns a frequency channel for communication to a mobile terminal is disclosed in Patent Document 1.

However, in a method in which the interference signal is detected in a base station side and the result is notified to the terminal, as disclosed in Patent Document 1 and Non-Patent Document 1, there is a problem that how a communication means to the terminal is configured. That is, although a specific means is not disclosed in Patent Document 1 and Non-Patent Document 1, a notification of the result of the interference detection must be received in a terminal side, and as a result, a reception waiting time becomes longer and power consumption of the terminal is increased.

And, since autonomous transmission from the terminal cannot be performed, realization of the above-mentioned terminal-initiated radio access control system becomes difficult, the system becomes complex and the power consumption of the terminal is increased.

In view of the above-mentioned problems, an objective of the present invention is to construct a radio communication system having the interference reduction function, enabling sharing of a frequency with other radio systems and enabling random access in which the load of the terminal is small.

### SUMMARY OF THE INVENTION

A representative example of the present invention is as follows. That is, the base station has an interference signal detection function, performs the interference signal detection intermittently and if the interference signal is not detected, transmits the beacon signal. The terminal starts up from a sleep mode before transmission of data and waits for data reception. The terminal transmits data only immediately after reception of the beacon signal and if the beacon signal is not received, transits to the sleep mode again. The abovementioned sequence is repeated after a predetermined time elapses.

Another representative example of the present invention is as follows. That is, the base station has the interference detection function, performs the interference detection intermittently and transmits the beacon signal having interference information added. The terminal starts up from the sleep mode before transmission of data and waits for data reception. After receiving the beacon signal, the terminal changes a transmission parameter according to the interference information and transmits data. If the beacon signal is not received, the terminal transits to the sleep mode again. The abovementioned sequence is repeated after a predetermined time elapses.

Specifically, a radio communication system according to the present invention is a radio communication system comprising a base station and a plurality of terminals having radio transmission-reception functions, wherein the base station has a function of transmitting a beacon signal and performs interference signal detection for detecting interference signals in frequency bands used for data transmission from the terminals to the base station before transmitting the beacon signal, and wherein each of the terminals transits from a waiting state having a radio reception function stopped to a reception waiting state of being capable of receiving the beacon signal before a timing of starting the data transmission and performs the data transmission only when the beacon signal is received.

And, a radio communication method according to the present invention is a radio communication method between a base station and a plurality of terminals, comprising the steps of: transmitting a beacon signal at the base station; detecting an interference signal in a frequency band used for radio communication from the terminals to the base station before the step of transmitting the beacon signal; providing the terminals transiting from a waiting state to beacon signal reception waiting before a timing of transmitting data; and transmitting the data only when the beacon signal is received.

According to the present invention, the interference reduction function is provided, the frequency sharing with other radio systems is realized, the random access is enabled, and as a result, power consumption reduction of the terminal is realized.

### BRIEF DESCRIPTIONS OF THE DRAWINGS

FIG. 1 is a configuration example of a radio communication system for a sensor network;

FIG. 2 is a configuration example of an interference signal detection unit according to a first embodiment;

FIG. 3A is a flow chart showing a base station sequence example according to the first embodiment of the present invention;

FIG. 3B is a flow chart showing a terminal sequence example according to the first embodiment of the present invention;

FIG. 4 is a diagram showing examples of states of a base station and a terminal, a data flow and power consumption of the terminal according to the first embodiment of the present invention;

FIG. 5A is a flow chart showing a base station sequence example according to a second embodiment of the present invention;

FIG. 5B is a flow chart showing a terminal sequence example according to the second embodiment of the present invention;

FIG. 6 is a diagram showing examples of states of a base station and a terminal and a data flow according to the second embodiment of the present invention;

FIG. 7A is a diagram showing an example of interference avoidance according to the second embodiment of the present invention;

FIG. 7B is a diagram showing an example of the interference avoidance according to the second embodiment of the present invention;

FIG. 8A is a flow chart showing a base station sequence example according to a third embodiment of the present invention;

FIG. 8B is a flow chart showing a terminal sequence example according to the third embodiment of the present invention;

FIG. 9 is a diagram showing examples of states of a base station and a terminal and a data flow according to the third embodiment of the present invention;

FIG. 10A is a flow chart showing a base station sequence example according to a fourth embodiment of the present invention;

FIG. 10B is a flow chart showing a terminal sequence example according to the fourth embodiment of the present invention;

FIG. 11 is a diagram showing examples of states of a base station and a terminal and a data flow according to the fourth embodiment of the present invention;

FIG. 12 is a diagram showing a configuration example of a base station according to a fifth embodiment of the present invention;

FIG. 13A is a flow chart showing a base station sequence example according to the fifth embodiment of the present invention;

FIG. 13B is a flow chart showing a terminal sequence example according to the fifth embodiment of the present invention;

FIG. 14 is a diagram showing examples of states of a base station and a terminal and a data flow according to the fifth embodiment of the present invention;

FIG. 15A is a flow chart showing a base station sequence example according to a sixth embodiment of the present invention;

FIG. 15B is a flow chart showing a terminal sequence example according to the sixth embodiment of the present invention; and

FIG. 16 is a diagram showing examples of states of a base station and a terminal and a data flow according to the sixth embodiment of the present invention.

### DESCRIPTIONS OF THE PREFERRED EMBODIMENTS

Hereinafter, embodiments of the present invention will be described with reference to the drawings.

### First Embodiment

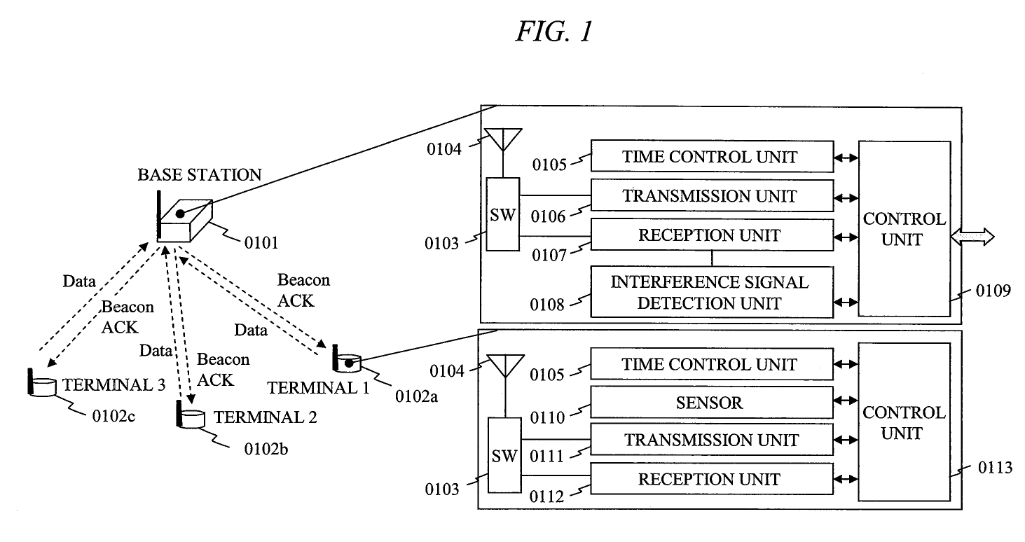

FIG. 1 shows a configuration diagram of an example of a radio communication system according to a first embodiment of the present invention. FIG. 1 shows a configuration diagram of a radio communication system of a sensor network as a representative example. In FIG. 1, 0101 is a base station, 0102 (a to c) are terminals 1 to 3, 0104 is an antenna, 0103 is a switch (SW), 0105 is a time control unit, 0106 is a base station side transmission unit, 0107 is a base station side reception unit, 0108 is an interference signal detection unit, 0109 is a base station side control unit, 0110 is a sensor unit, 0111 is a terminal side transmission unit, 0112 is a terminal side reception unit, and 0113 is a control unit.

The base station 0101 comprises the base station side transmission unit 0106 of being capable of transmitting a Beacon signal and an ACK signal, and the base station side reception unit 0107 of being capable of receiving Data signals from the terminals 0102. Each of the terminals 0102 comprises the terminal side reception unit 0112 of being capable of receiving the Beacon signal and the ACK signal, and the terminal side transmission unit 0111 of being capable of transmitting the Data signal including sensing data obtained from the sensor unit 0110.

And, the base station 0101 comprises an interference signal detection unit detecting radio signals of other radio systems (hereinafter referred to as “interference signals”) existing in a frequency band used for radio communication from the terminals 0102 to the base station 0101.

For example, the interference signal detection unit has a function of detecting an interference signal exceeding a threshold in a frequency range F with a frequency resolution of dF. For example, if dF=10 MHz and F=3.4 GHz to 4.8 GHz, existence and nonexistence of the interference signal can be detected at 80 points of 10 MHz band in 800 MHz band between 3.4 GHz and 4.2 GHz.

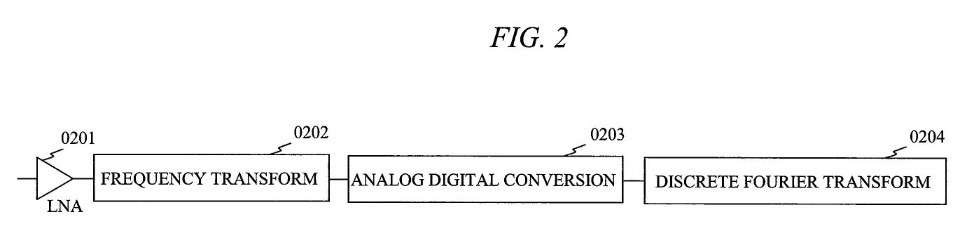

FIG. 2 shows a configuration example of the interference signal detection unit 0108. In FIG. 2, 0201 is a low noise amplifier (LNA), 0202 is a frequency transform unit, 0203 is an analog digital conversion unit, and 0204 is a discrete Fourier transform unit.

And, if radio systems to be detected are limited, the interference signal detection unit 0101 can be provided with a receiver for the radio systems to detect signal levels thereof.

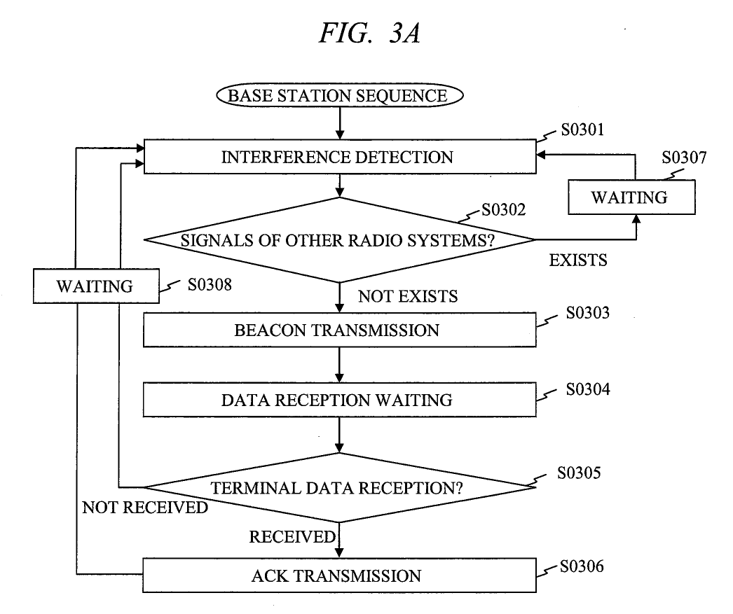

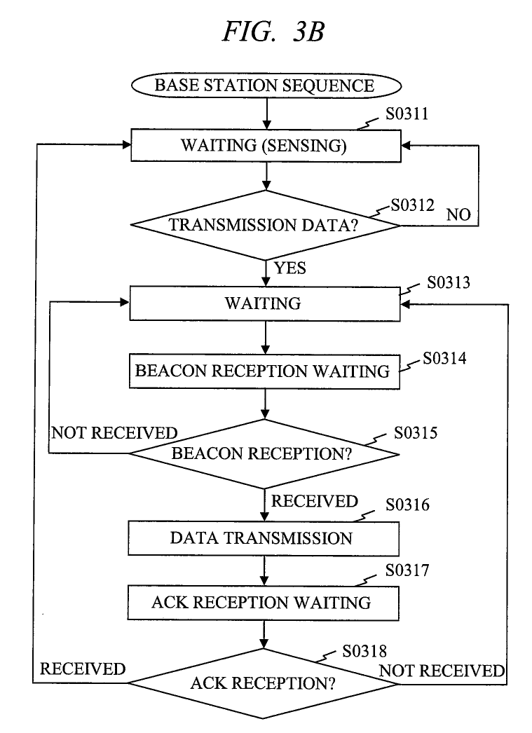

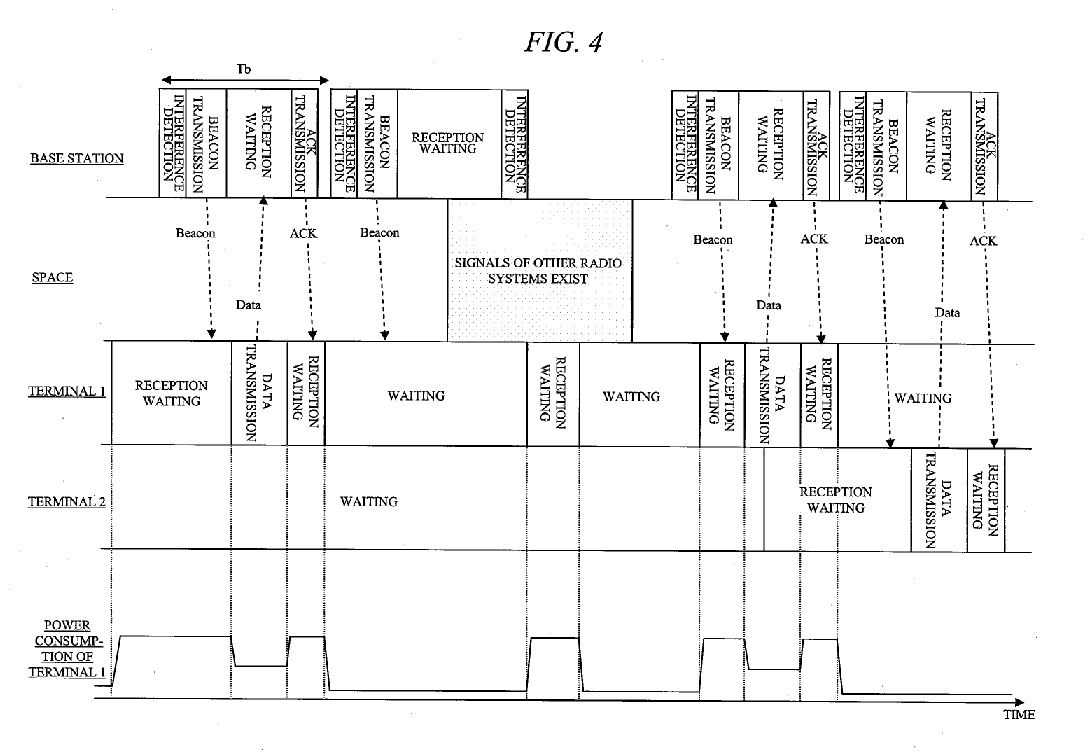

Control units 0109 and 0113 realize operation at the base station and the terminal described using FIG. 3A to FIG. 4.

FIG. 3A and FIG. 3B are flow charts showing sequence examples of the base station and the terminal according to the first embodiment, and FIG. 4 shows examples of states of the base station and the terminal and a data flow of operation of the flow charts shown in FIGS. 3A and 3B.

Firstly, the base station performs interference signal detection (S0301). As a result, if an interference signal exists in a band, a predetermined time is spent for waiting (S0307), and the interference signal detection is repeated. If no interference signal exists in the band as a result of the interference signal detection, the base station transmits a Beacon signal (S0303), and transits to a Data signal reception waiting (S0304). When Data from the terminal is received, the base station transmits an ACK signal (S0306), waits for a predetermined time (S0308), and then, transits to the next interference detection. If the Data from the terminal is not received for a predetermined time, the base station transits to the next interference detection. Each of the abovementioned waiting (S0307, S0308) is adjusted so that intervals between interference detections are constant time (Tb). Note that, different intervals can be set depending on whether the interference signal is detected.

The ACK signal is not necessarily needed depending on reliability required for the system. If the ACK signal is not needed, a step of ACK transmission (S0306) is omitted.

The terminal waits (S0311), and if data to be transmitted exists (S0312), after waiting for a predetermined time (S0313), transits to a Beacon signal reception waiting (S0314). If an arrival time of the Beacon signal from the base station can be estimated from the last reception of the Beacon signal, the terminal transits from the waiting (S0313) to the Beacon signal reception waiting in accordance with the time. If the arrival time of the Beacon signal cannot be estimated, for example, in a first transmission, the terminal transits to the Beacon signal reception waiting immediately or after waiting for a random time. When the terminal waits for the random time, access control of a pseudo-ALOHA system can be realized. Therefore, a time of the waiting (S0313) may be 0.

If the Beacon signal is not received, the terminal transits to the waiting (S0313) again, and waits for a reception timing of the Beacon signal of a next timing.

When the Beacon signal is received, the Data signal is transmitted (S0316). Then, the terminal transits to ACK reception waiting (S0317), and waits for reception of the ACK signal. If the ACK signal is not received for a predetermined time, the terminal transits to a waiting state (S0313) again, and waits for a reception timing of the Beacon signal of a next timing.

When the ACK signal is received, the terminal transits to waiting (S0311) waiting for a timing of transmitting data to be transmitted in a next time. In a case of a system using no ACK signal, steps S0317 and S0318 are omitted and the terminal immediately transits to the waiting (S0311) waiting for a timing of transmission.

In a case of a sensor network, sensing is performed in the waiting (S0311) and data to be transmitted is obtained, for example.

In the waiting (S0311, S0313) of the terminal described above, power sources of the transmission unit 0111 and the reception unit 0112 are shut down.

Once receiving data from a certain terminal, the base station can realize a pseudo-TDMA system by assigning communication timings of a next time and thereafter to the terminal and notifying the same using the ACK signal. In this operation, the Beacon signals of the communication timings of the next time and thereafter are made to include ID information of the terminal so that other terminals cannot perform transmission even if they receive the beacon signal, thereby preventing collision of terminals, and improving a throughput of the system.

Examples of states of the base station and the terminal and a data flow realized by the abovementioned flow charts are shown in FIG. 4.

In the radio communication system described above, although the interference reduction function of being capable of sharing a frequency with other radio systems is provided, a complex structure is not required for the terminal and a cost for the system can be reduced. The terminal-initiated random access can be performed, and as a result, power consumption can be reduced.

FIG. 4 shows a schematic graph of power consumption of the terminal 1. As shown in the graph, transmission from the terminal is performed intermittently, and reception operation must be performed only before and after the transmission. The power consumption of the terminal can be reduced by stopping power to the transmission unit and the reception unit in waiting, that is, a period other than the transmission and the reception.

The radio system described above can be constructed using different radio systems in transmission from the base station to a terminal and in transmission from the terminal to the base station. That is, in FIG. 1, the base station side transmission unit 0106 and the terminal side reception unit 0112 are made to correspond to a radio system A, and the base station side reception unit 0107 and the terminal side transmission unit 0111 are made to correspond to a radio system B. In this case, for example, if power consumption in reception of the radio system A is lower than that of the radio system B, and a transmission speed of the radio system B is higher than that of the radio system A, communication of the Beacon signal and the ACK signal is performed with a low transmission rate and low power consumption in reception, and communication of the Data signal is performed with a high transmission rate to reduce a transmission time. And therefore, the power consumption of the terminal can be further reduced.

As an example of the abovementioned system, a narrow-band radio system represented by a radio specification IEEE 802.15.4 for a sensor network is used as the radio system A, and a UWB system is used as the radio system B.

### Second Embodiment

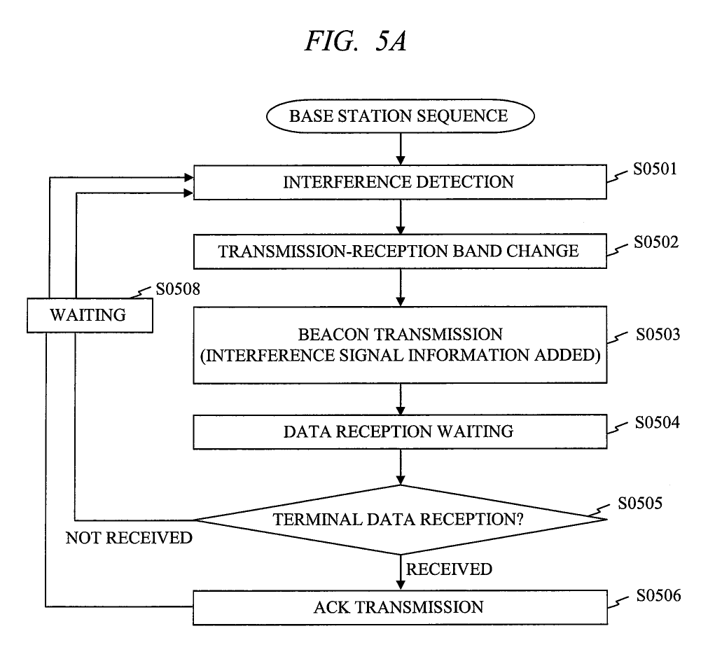

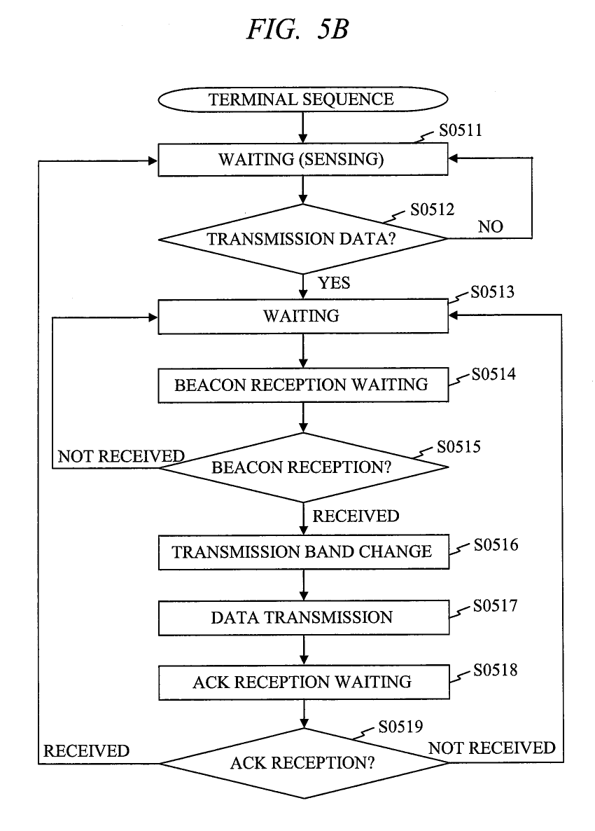

A radio system according to a second embodiment of the present invention is described using FIGS. 5A to 7B. One of configuration examples of the radio systems according to the second embodiment can be illustrated by the configuration example of FIG. 1.

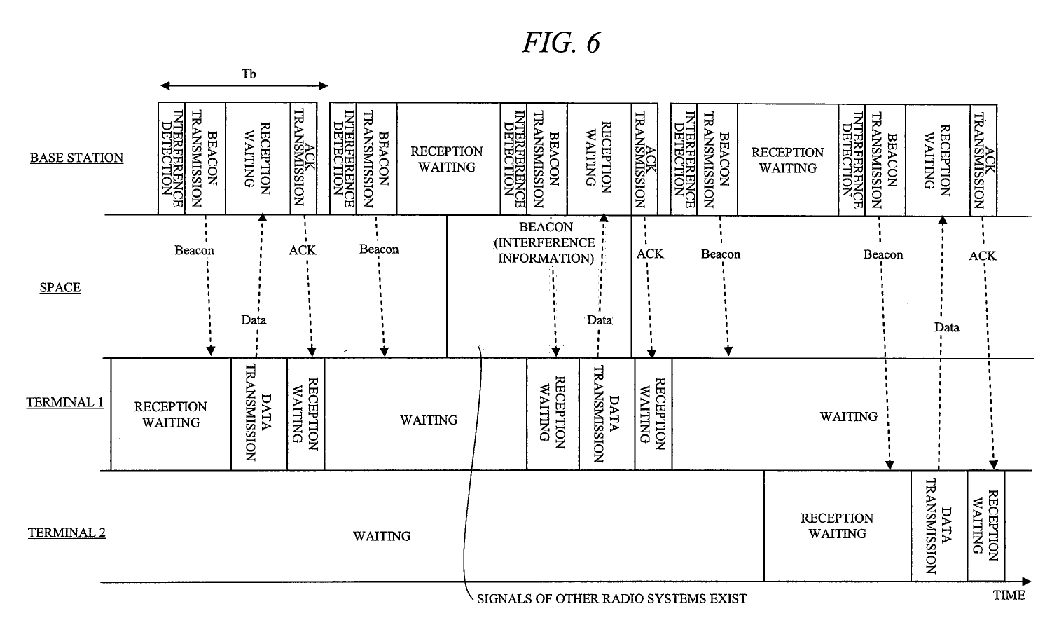

FIG. 5A and FIG. 5B are flow charts showing sequence examples of a base station and a terminal according to the second embodiment, and FIG. 6 shows examples of states of the base station and the terminal and a data flow realized by operation in the flowcharts shown in FIG. 5A and FIG. 5B.

Firstly, the base station performs interference signal detection (S0501). The base station adds interference signal information obtained as a result of the interference signal detection to a Beacon signal and transmits the Beacon signal (S0503). Then, the base station transits to Data signal reception waiting (S0504). And, setting of a reception band of a receiver is changed based on the result of the interference signal detection (S0502).

When Data from the terminal is received, the base station transmits an ACK signal (SO506), and transits to next interference detection after waiting for a predetermined time (S0508). If the Data from the terminal is not received for a predetermined time, the base station transits to next interference detection. The abovementioned waiting (S0508) is adjusted so that intervals between interference detections are constant time (Tb).

The ACK signal is not necessarily needed depending on reliability required for the system. If the ACK signal is not needed, a step of ACK transmission (S0506) is omitted.

The terminal waits (S0511), and if data to be transmitted exists (S0512), after waiting for a predetermined time (S0513), transits to a Beacon signal reception waiting (S0514). If an arrival time of the Beacon signal from the base station can be estimated to a certain degree from the last reception of the Beacon signal, the terminal transits from the waiting (S0513) to the Beacon signal reception waiting in accordance with the time. If the arrival time of the Beacon signal cannot be estimated, for example, in a first transmission, the terminal transits to the Beacon signal reception waiting immediately or after waiting for a random time. When the terminal waits for the random time, access control of a pseudo-ALOHA system can be realized. Therefore, a time of the waiting (S0513) may be 0.

If the Beacon signal is not received, the terminal transits to the waiting (S0513) again, and waits for a reception timing of the Beacon signal of a next timing.

When the Beacon signal is received, a transmission band of a transmission unit is changed according to the interference signal information in the Beacon signal (S0516), and the Data signal is transmitted (S0517). Then, the terminal transits to ACK reception waiting (S0518), and waits for reception of the ACK signal. If the ACK signal is not received for a predetermined time, the terminal transits to a waiting state (S0513) again, and waits for a reception timing of the Beacon signal of a next timing.

When the ACK signal is received, the terminal transits to waiting (S0511) waiting for a timing of transmitting data to be transmitted in a next time. In a case of a system using no ACK signal, steps S0518 and S0519 are omitted and the terminal immediately transits to the waiting (S0511) waiting for a timing of transmission.

In the waiting (S0511, S0513) of the terminal described above, power sources of the transmission unit 0111 and the reception unit 0112 are shut down.

In a case of a sensor network, sensing is performed in the waiting (S0511) and data to be transmitted is obtained, for example.

Examples of states of the base station and the terminal and a data flow realized by the abovementioned flow charts are shown in FIG. 6.

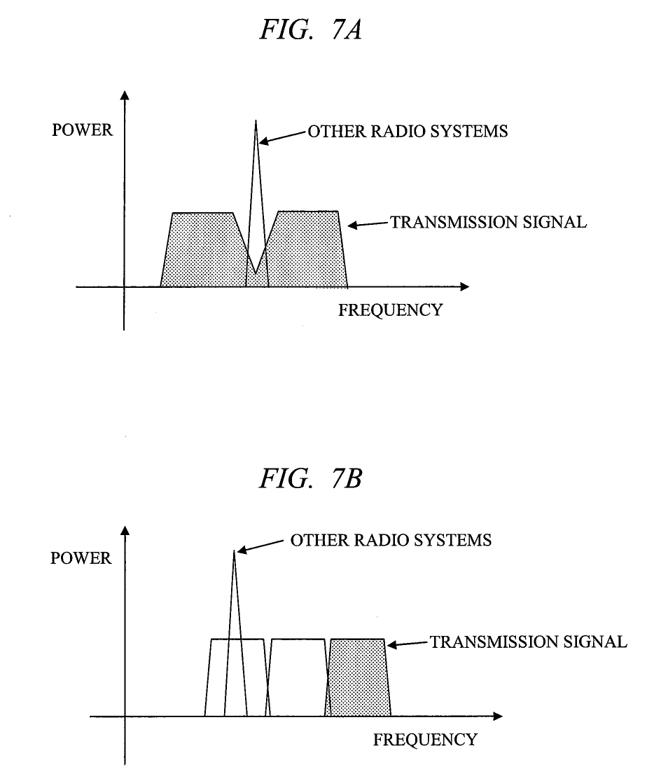

FIGS. 7A and 7B are diagrams schematically showing examples of change control of the transmission band of S0516. Both of FIG. 7A and FIG. 7B show relationship diagrams of power spectrums of a detected interference signal and a transmission signal. In FIG. 7A, a band in which the interference signal exists is notched a transmission signal is transmitted. This is effective in a system adopting OFDM, for example. That is, a notch is formed by transmitting without assigning information to a subcarrier corresponding to the band in which the detected interference signal exists.

FIG. 7B shows that if a plurality of frequency channels exists and the interference signal exists in one channel, a channel for transmission is changed.

In both cases, data transmission can be performed even if the interference signal exists, and therefore, decrease of a throughput can be suppressed.

In the radio communication system described above, although the interference reduction function of being capable of sharing a frequency with other radio systems is provided, a complex structure is not required for the terminal and a cost for the system can be reduced. The terminal-initiated random access can be performed, and as a result, power consumption can be reduced.

In the same way as the first embodiment, the radio system described above can be constructed using different radio systems in transmission from the base station to a terminal and in transmission from the terminal to the base station.

### Third Embodiment

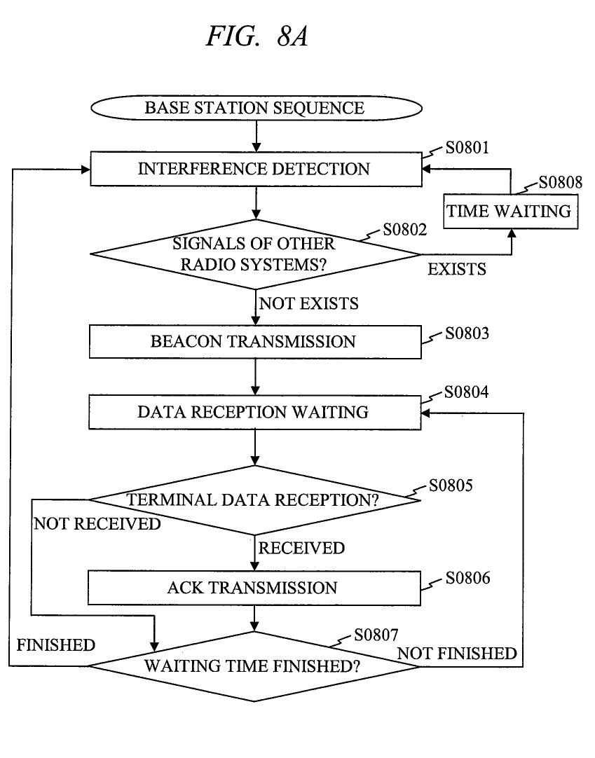

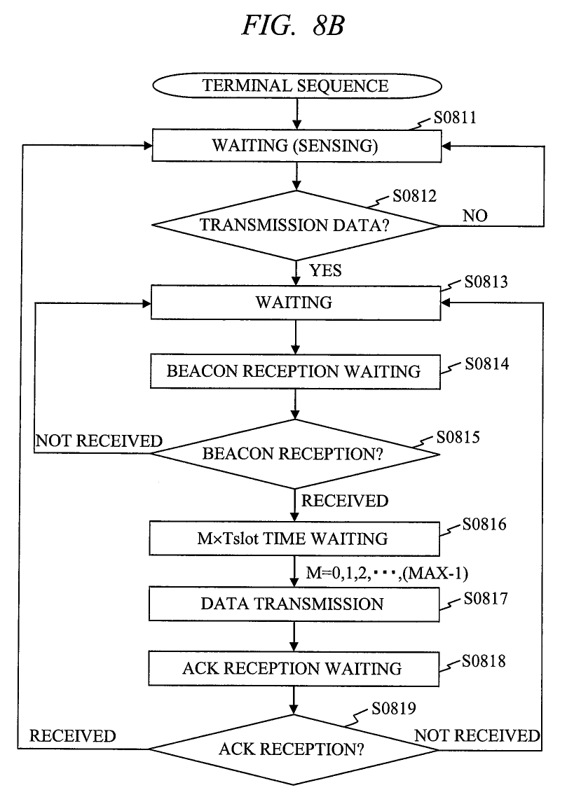

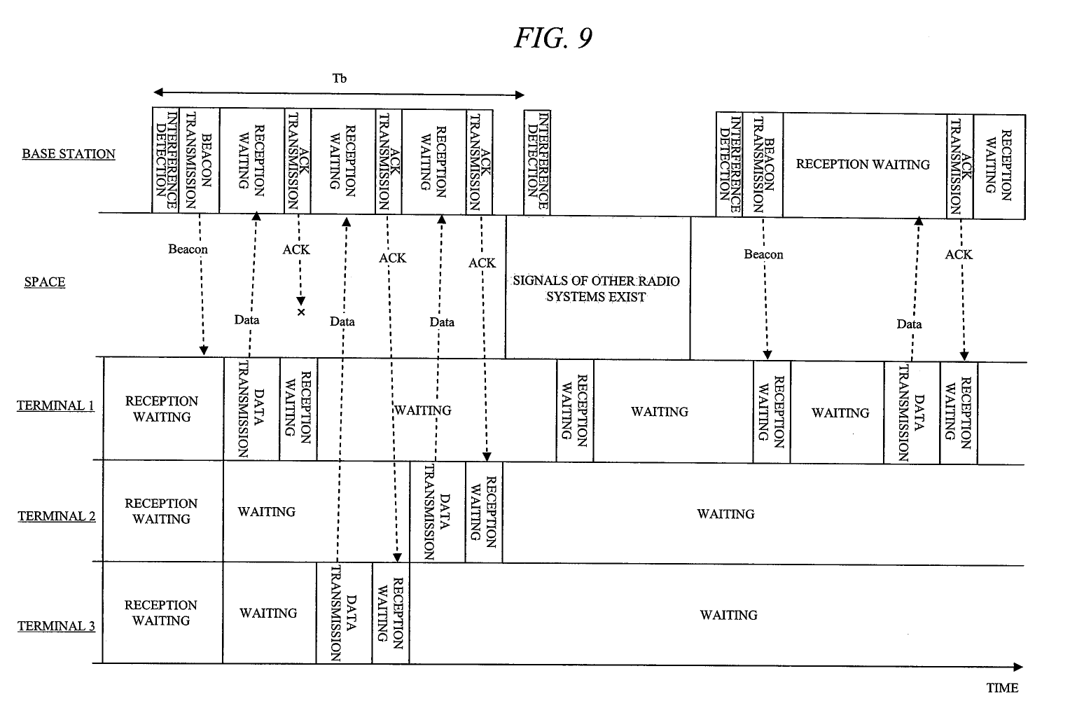

A radio system according to a third embodiment of the present invention is described using FIGS. 8A to 9. One of configuration examples of the radio system according to the third embodiment can be illustrated by the configuration example of FIG. 1.

FIG. 8A and FIG. 8B are flow charts showing sequence examples of a base station and a terminal according to the first embodiment, and FIG. 9 shows examples of states of the base station and the terminal and a data flow realized by operation in the flow charts shown in FIG. 8A and FIG. 8B.

Firstly, the base station performs interference signal detection (S0801). As a result, if an interference signal exists in a band, a predetermined time is spent for waiting (S0808), and the interference signal detection is repeated. If no interference signal exists in the band as a result of the interference signal detection, the base station transmits a Beacon signal (S0803), and transits to a Data signal reception waiting (S0804). When Data from the terminal is received, the base station transmits an ACK signal (S0806). After transmission of the ACK signal, if a predetermined time elapses after start of Data reception waiting, the base station returns to interference detection (S0801). If the Data signal is not received, waiting is continued until a predetermined time elapses after start of reception waiting. This predetermined time is adjusted so that intervals between interference detections are constant time (Tb).

The ACK signal is not necessarily needed depending on reliability required for the system. If the ACK signal is not needed, a step of ACK transmission (S0806) is omitted.

The terminal waits (S0811), and if data to be transmitted exists (S0812), after waiting for a predetermined time (S0813), transits to a Beacon signal reception waiting (S0814). If an arrival time of the Beacon signal from the base station can be estimated to a certain degree from the last reception of the Beacon signal, the terminal transits from the waiting (S0813) to the Beacon signal reception waiting in accordance with the time. If the arrival time of the Beacon signal cannot be estimated, for example, in a first transmission, the terminal transits to the Beacon signal reception waiting immediately or after waiting for a random time. When the terminal waits for the random time, access control of a pseudo-ALOHA system can be realized. Therefore, a time of the waiting (S0813) may be 0.

If the Beacon signal is not received, the terminal transits to a waiting state (S0813) again, and waits for a reception timing of the Beacon signal of a next timing.

When the Beacon signal is received, after waiting for M×Tslot time (S0816), the terminal transmits the Data signal (S0817). Here, the M is a random integer value selected from 0 to (MAX-1), and the Tslot is a time (slot) assigned to one Data transmission and ACK reception. The MAX is the number of slots in the interval of interference detection.

Then, the terminal transits to ACK reception waiting (S0818), and waits for reception of the ACK signal. If the ACK signal is not received for a predetermined time, the terminal transits to the waiting state (S0813) again, and waits for a reception timing of the Beacon signal of a next timing.

When the ACK signal is received, the terminal transits to waiting (S0811) waiting for a timing of transmitting data to be transmitted in a next time. In a case of a system using no ACK signal, steps S0818 and S0819 are omitted and the terminal immediately transits to the waiting (S0811) waiting for a timing of transmission.

In the waiting (S0811, S0813) of the terminal described above, power sources of the transmission unit 0111 and the reception unit 0112 are shut down.

Once receiving data from a certain terminal, the base station can realize a pseudo-TDMA system by assigning communication timings of a next time and thereafter to the terminal and notifying the same using the ACK signal. In this operation, the Beacon signals of the communication timings of the next time and thereafter are made to include ID information of the terminal so that other terminals cannot perform transmission even if they receive the beacon signal, thereby preventing collision of terminals, and improving a throughput of the system.

Examples of states of the base station and the terminal and a data flow realized by the abovementioned flow charts are shown in FIG. 9.

According to the present embodiment, a plurality of terminals can perform Data transmission for one Beacon signal, collision of the Data can be avoided and the throughput of the system can be improved. Note that, since a certain period of time is required after the interference signal detection, the present embodiment can be applied only when a system to be interfered can permit transmission after the abovementioned period of time elapses.

In the radio communication system described above, although the interference reduction function of being capable of sharing a frequency with other radio systems is provided, a complex structure is not required for the terminal and a cost for the system can be reduced. The terminal-initiated random access can be performed, and as a result, power consumption can be reduced.

In the same way as the first embodiment, the radio system described above can be constructed using different radio systems in transmission from the base station to a terminal and in transmission from the terminal to the base station.

### Fourth Embodiment

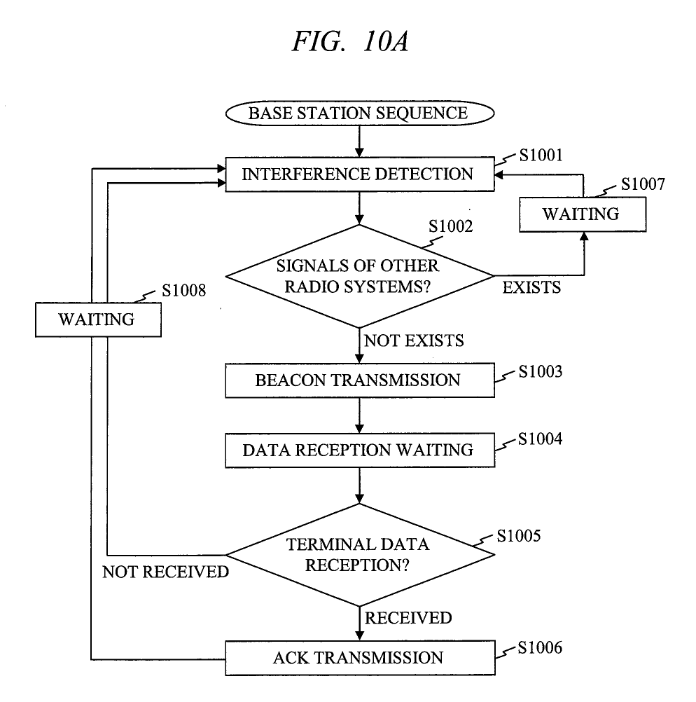

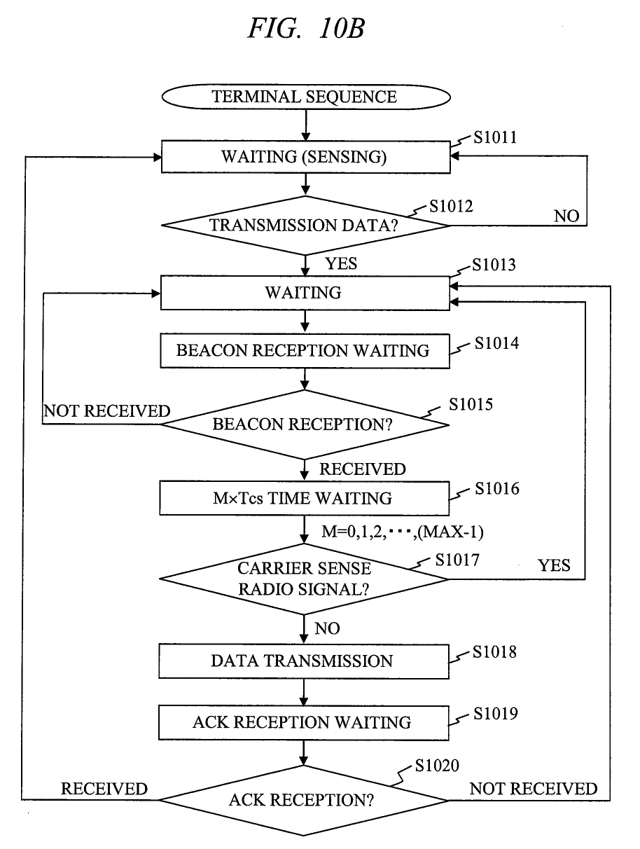

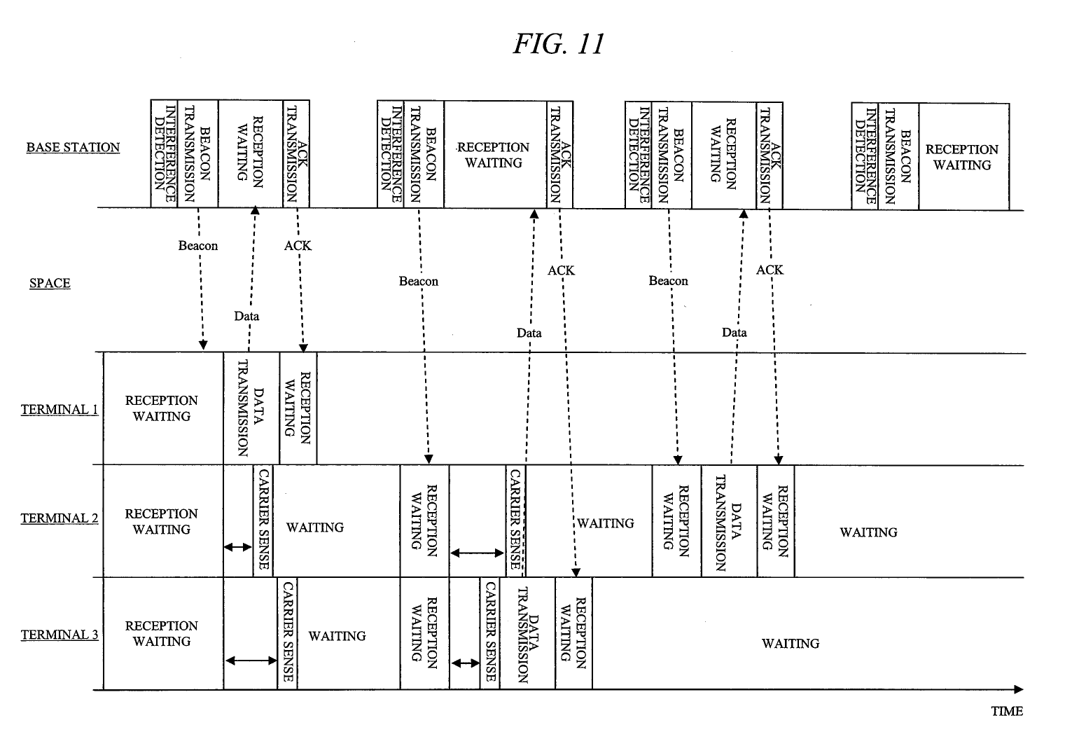

A radio system according to a fourth embodiment of the present invention is described using FIGS. 10A to 11. One of configuration examples of the radio system according to the fourth embodiment can be illustrated by the configuration example of FIG. 1. The terminal side reception unit 0112 in FIG. 1 has a carrier sense function of detecting existence and nonexistence of signals transmitted by other terminals 0102 and the base station 0101 in the radio communication system.

FIG. 10A and FIG. 10B are flow charts showing sequence examples of a base station and a terminal according to the fourth embodiment, and FIG. 11 shows examples of states of the base station and the terminal and a data flow realized by operation in the flow charts shown in FIG. 10A and FIG. 10B.

Firstly, the base station performs interference signal detection (S1001). As a result, if an interference signal exists in a band, a predetermined time is spent for waiting (S1007), and the interference signal detection is repeated. If no interference signal exists in the band as a result of the interference signal detection, the base station transmits a Beacon signal (S1003), and transits to a Data signal reception waiting (S1004). When Data from the terminal is received, the base station transmits an ACK signal (S1006), waits for a predetermined time (S1008), and then, transits to the next interference detection. If the Data from the terminal is not received for a predetermined time, the base station transits to the next interference detection. Each of the abovementioned waiting (S1007, S1008) is adjusted so that intervals between interference detections are constant time (Tb). Note that, different intervals can be set depending on whether the interference signal is detected.

The ACK signal is not necessarily needed depending on reliability required for the system. If the ACK signal is not needed, a step of ACK transmission (S1006) is omitted.

The terminal waits (S1011), and if data to be transmitted exists (S1012), after waiting for a predetermined time (S1013), transits to a Beacon signal reception waiting (S1014). If an arrival time of the Beacon signal from the base station can be estimated to a certain degree from the last reception of the Beacon signal, the terminal transits from the waiting (S1013) to the Beacon signal reception waiting in accordance with the time. If the arrival time of the Beacon signal cannot be estimated, for example, in a first transmission, the terminal transits to the Beacon signal reception waiting immediately or after waiting for a random time. When the terminal waits for the random time, access control of a pseudo-ALOHA system can be realized. Therefore, a time of the waiting (S1013) may be 0.

If the Beacon signal is not received, the terminal transits to a waiting state (S1013) again, and waits for a reception timing of the Beacon signal of a next timing.

When the Beacon signal is received, after waiting for M×Tcs time (S1016), the terminal performs carrier sense (S1017). If a radio signal in the same radio system is not detected by the carrier sense, Data signal transmission is performed (S1018).

If the radio signal in the same radio system is detected, the terminal returns to the waiting (S1013) and waits for a reception timing of the Beacon signal of a next timing.

Here, the M is a random integer value selected from 0 to (MAX-1), and the Tcs is a time (slot) assigned to one carrier sense. The MAX is a max number of the carrier sense. The carrier sense is not performed when M=0, and the Data signal transmission is performed (S1018).

Then, the terminal transits to ACK reception waiting (S1019), and waits for reception of the ACK signal. If the ACK signal is not received for a predetermined time, the terminal transits to the waiting state (S1013) again, and waits for a reception timing of the Beacon signal of a next timing.

When the ACK signal is received, the terminal transits to waiting (S1011) waiting for a timing of transmitting data to be transmitted in a next time. In a case of a system using no ACK signal, steps S1019 and S1020 are omitted and the terminal immediately transits to the waiting (S1011) waiting for a timing of transmission.

In the waiting (S1011, S1013) of the terminal described above, power sources of the transmission unit 0111 and the reception unit 0112 are shut down.

Examples of states of the base station and the terminal and a data flow realized by the abovementioned flow charts are shown in FIG. 11.

According to the present embodiment, collision of the Data signals can be avoided when a plurality of terminals performs reception for one Beacon signal, and a throughput of the whole system can be improved.

In the radio communication system described above, although the interference reduction function of being capable of sharing a frequency with other radio systems is provided, a complex structure is not required for the terminal and a cost for the system can be reduced. The terminal-initiated random access can be performed, and as a result, power consumption can be reduced.

In the same way as the first embodiment, the radio system described above can be constructed using different radio systems in transmission from the base station to a terminal and in transmission from the terminal to the base station.

### Fifth Embodiment

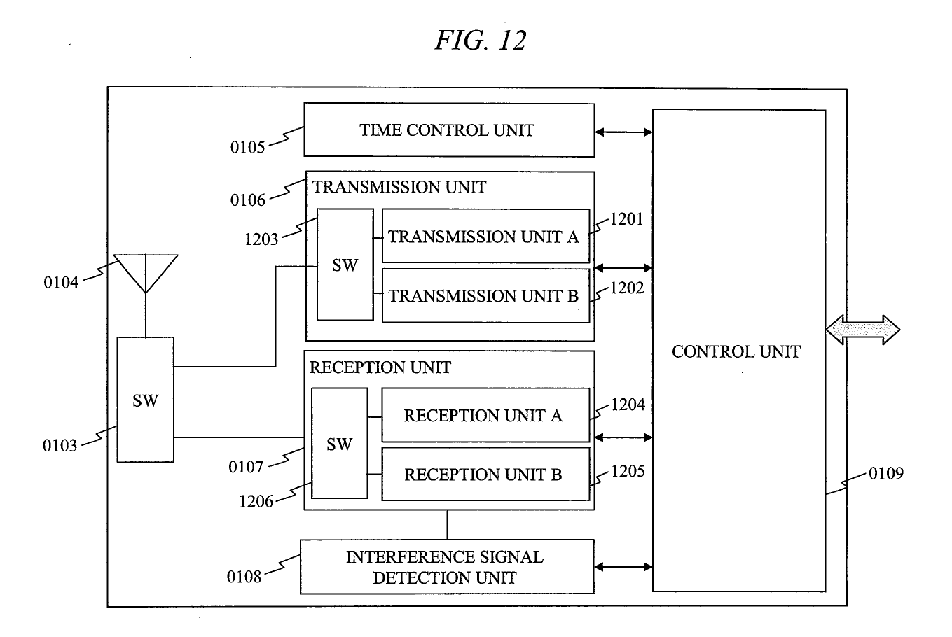

A radio system according to a fifth embodiment of the present invention is described using FIGS. 12 to 14. One of configuration examples of the radio system according to the fifth embodiment can be illustrated by the configuration example of FIG. 1.

FIG. 12 shows a configuration example of the base station 0101 in FIG. 1 according to the present embodiment. Although the configuration example shown in FIG. 12 is the same as the configuration example of the base station in FIG. 1, the transmission unit 0106 has a function of being capable of transmitting signals of both of a first radio system (hereinafter referred to as radio system A) and a second radio system (hereinafter referred to as radio system B). In the configuration example in FIG. 12, a transmission unit A 1201 and a transmission unit B 1202 corresponding to the radio system A and the radio system B respectively, and a switch (SW) 1203 are provided, and the abovementioned function is selected by a control unit 0109.

Similarly, a reception unit 0107 has a function of being capable of receiving signals of both of the radio system A and the radio system B. In the configuration example in FIG. 12, a reception unit A 1204 and a reception unit B 1205 corresponding to the radio system A and the radio system B respectively, and a switch (SW) 1206 are provided, and the abovementioned function is selected by the control unit 0109.

And, the terminal side transmission unit 0111 and the terminal side reception unit 0112 configuring the terminal 0102 in FIG. 1 also have the same functions as the base station side transmission unit 0106 and the base station side reception unit 0107, respectively.

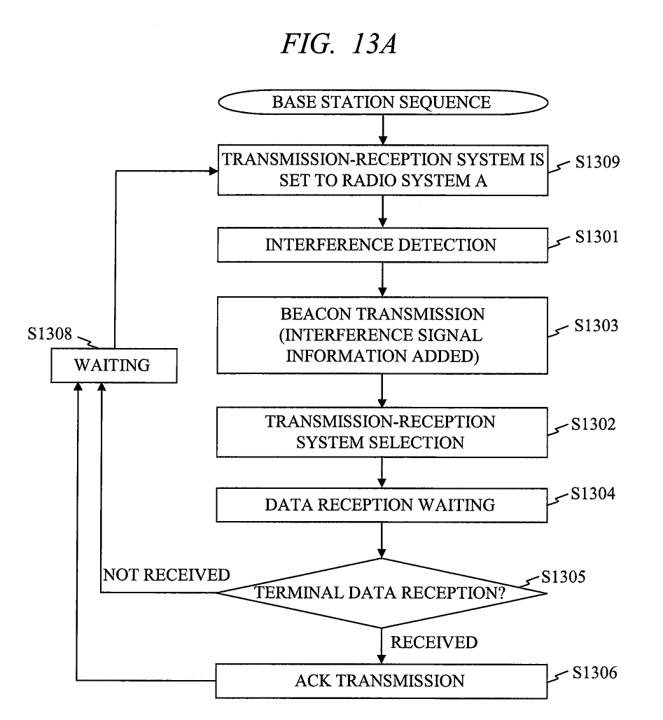

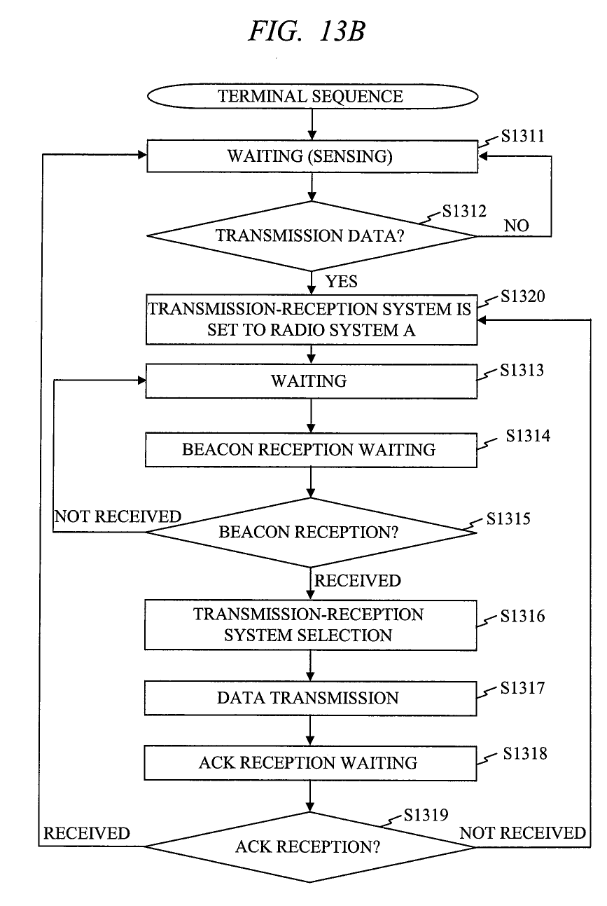

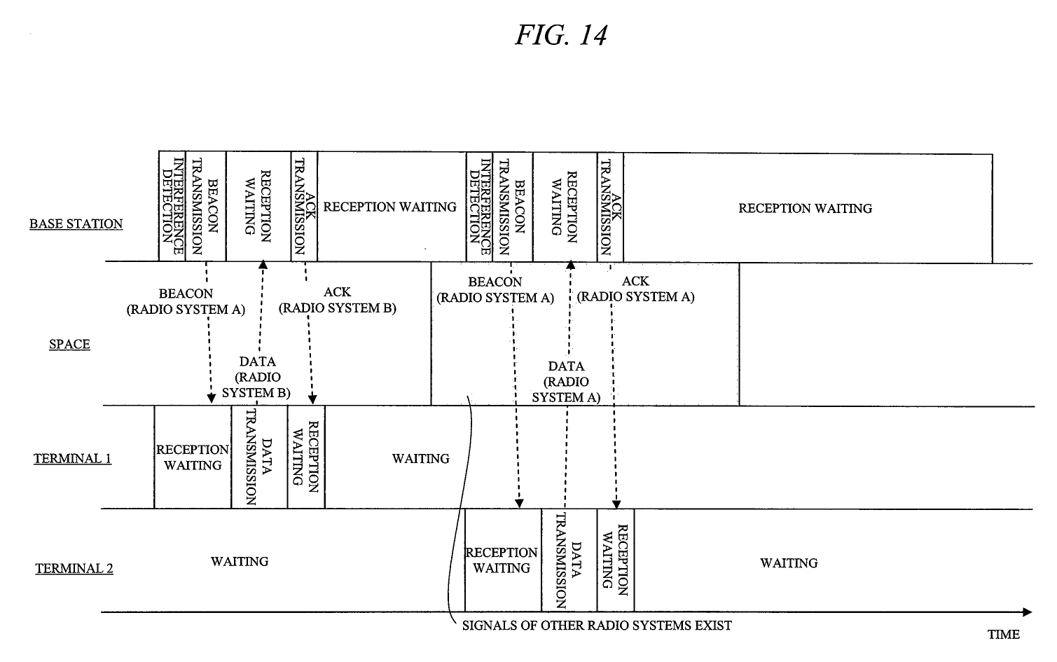

FIG. 13A and FIG. 13B are flow charts showing sequence examples of the base station and the terminal according to the fifth embodiment, and FIG. 14 shows examples of states of the base station and the terminal and a data flow realized by operation in the flow charts shown in FIG. 13A and FIG. 13B.

At first, both of the base station and the terminal are set to be able to perform transmission and reception by the radio system A (S1309). The base station performs interference signal detection at first (S1301), adds interference signal information obtained as a result of the interference signal detection to a Beacon signal, transmits the Beacon signal by the radio system A (S1303), and transits to a Data signal reception waiting (S1304). One of the radio system A and the radio system B is selected for transmission based on the result of the interference signal detection. That is, the radio system having a band in which no interference signal exists is selected.

When Data from the terminal is received, the base station transmits an ACK signal (S13O6), and transits to next interference detection after waiting for a predetermined time (S1308). If the Data from the terminal is not received for a predetermined time, the base station transits to next interference detection. The abovementioned waiting (S1308) is adjusted so that intervals between interference detections are constant time (Tb). Before the terminal transits to the next interference detection, a transmission-reception system is set to the radio system A (S1309).

The ACK signal is not necessarily needed depending on reliability required for the system. If the ACK signal is not needed, a step of ACK transmission (S1306) is omitted.

The terminal waits (S1311), and if data to be transmitted exists (S1312), after waiting for a predetermined time (S1311, S1312, S1313), transits to a Beacon signal reception waiting (S1314). The Beacon is received by the radio system A.

If an arrival time of the Beacon signal from the base station can be estimated to a certain degree from the last reception of the Beacon signal, the terminal transits from the waiting (S1313) to the Beacon signal reception waiting in accordance with the time. If the arrival time of the Beacon signal cannot be estimated, for example, in a first transmission, the terminal transits to the Beacon signal reception waiting immediately or after waiting for a random time. When the terminal waits for the random time, access control of a pseudo-ALOHA system can be realized. Therefore, a time of the waiting (S1313) may be 0.

If the Beacon signal is not received, the terminal transits to a waiting state (S1313) again, and waits for a reception timing of the Beacon signal of a next timing.

When the Beacon signal is received, a radio system is selected based on the interference signal information in the Beacon signal (S1316) and a Data signal is transmitted (S1317). Then, the terminal transits to ACK reception waiting (S1318) and waits for reception of an ACK signal. If the ACK signal is not received for a predetermined time, the terminal transits to the waiting state (S1313) again and waits for a reception timing of the Beacon signal of a next timing. In this step, the transmission-reception system is returned to the radio system A (S1320).

When the ACK signal is received, the terminal transits to waiting (S1311) waiting for a timing of transmitting data to be transmitted in a next time. In a case of a system using no ACK signal, steps S1318 and S1319 are omitted and the terminal immediately transits to the waiting (S1311) waiting for a timing of transmission.

Examples of states of the base station and the terminal and a data flow realized by the abovementioned flow charts are shown in FIG. 14.

In the waiting (S1311, S1313) of the terminal described above, power sources of the transmission unit 0111 and the reception unit 0112 are shut down.

In the radio system described above, radio systems using different frequency bands are preferably adopted as the radio system A and the radio system B. A radio system having no system interfering thereto is set to the radio system A, and a radio system having possibilities of being interfered is set to the radio system B. For example, in a case where a narrow-band radio system represented by IEEE 802.15.4 is adopted as the radio system A and UWB is adopted as the radio system B, if there is no interfering radio system, effective communication utilizing a feature of the UWB can be performed, and if other radio systems exist, decrease of the throughput of the system is prevented by using the narrow-band radio system.

And, combination of the radio system A and the radio system B is not restricted, the number of the radio system is not limited to 2 but can be increased such as 3, 4 to improve the reliability of the system. Furthermore, by combining one of the radio systems with a wired system such as PLC (Power Line Communication), a radio communication system having still higher efficiency and still higher reliability can be constructed.

In the radio communication system described above, although the interference reduction function of being capable of sharing a frequency with other radio systems is provided, a complex structure is not required for the terminal and a cost for the system can be reduced. The terminal-initiated random access can be performed, and as a result, power consumption can be reduced.

### Sixth Embodiment

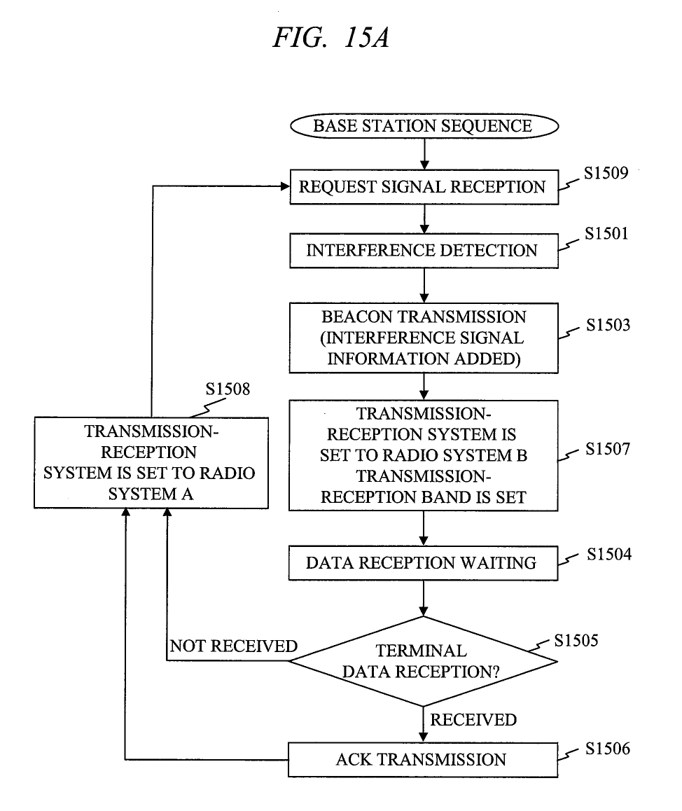

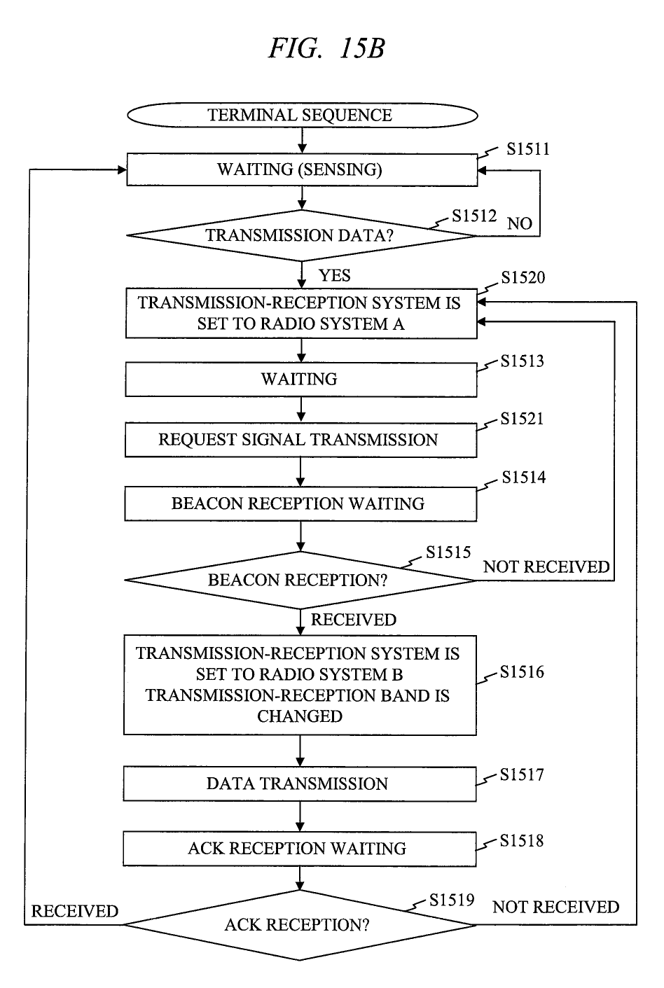

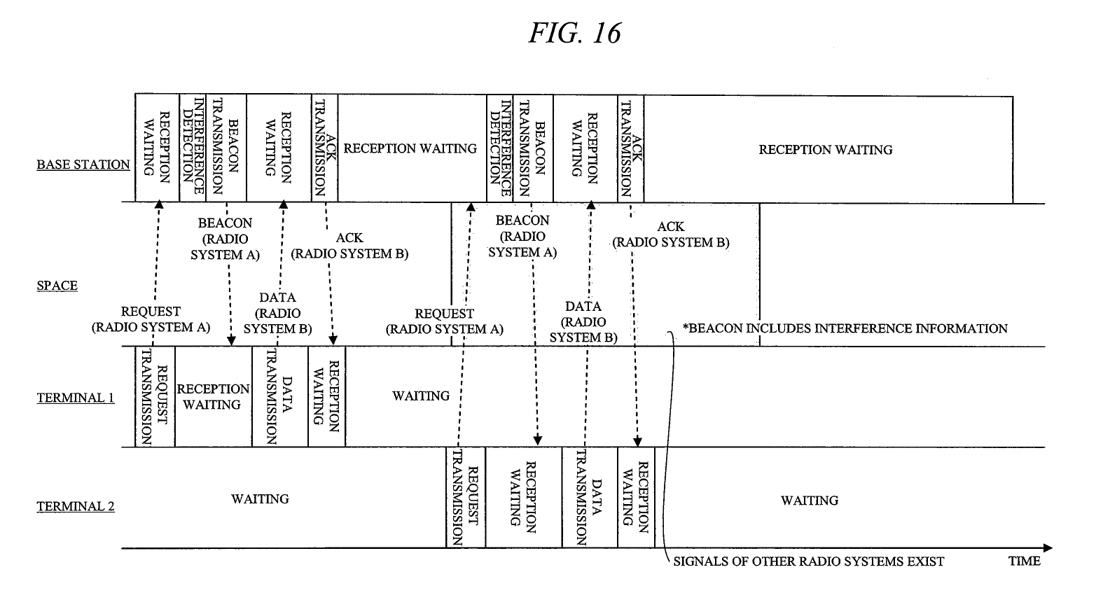

A radio system according to a sixth embodiment of the present invention is described using FIGS. 15A to 16. One of configuration examples of the radio system according to the sixth embodiment can be illustrated by the configuration example of FIG. 1. And, in the same manner as the fifth embodiment, base station side and terminal side transmission units and reception units can be illustrated by the configuration examples in FIG. 12.

FIG. 15A and FIG. 15B are flow charts showing sequence examples of the base station and the terminal according to the sixth embodiment, and FIG. 16 shows examples of states of the base station and the terminal and a data flow realized by operation in the flow charts shown in FIG. 15A and FIG. 15B.

At first, both of the base station and the terminal are set to be able to perform transmission-reception by the radio system A. First, the base station waits for a Request signal using the radio system A (S1509). When the Request signal is received, interference signal detection is performed (S1501). The base station adds interference signal information obtained as a result of the interference signal detection to a Beacon signal, transmits the Beacon signal (S1503), and transits to a Data signal reception waiting (S1504). The Data signal reception waiting in this step is set to the radio system B, and a transmission-reception band is set based on the interference signal information (S1507). This operation is the same as the method of avoiding an interference signal band described in the second embodiment.

When Data from the terminal is received, the base station transmits an ACK signal (S1506), returns the transmission-reception system to the radio system A (S1508), and then transits to reception waiting of the Request signal. Similarly, if the Data from the terminal is not received for a predetermined time, the base station returns the transmission-reception system to the radio system A (S1508), and then transits to the receipt waiting of the Request signal.

The ACK signal is not necessarily needed depending on reliability required for the system. If the ACK signal is not needed, a step of ACK transmission (S1506) is omitted.

The terminal waits (S1511), and if data to be transmitted exists (S1512), after waiting for a predetermined time (S1513), transmits the Request signal by the radio system A (S1521). In this waiting (S1513), access control of a pseudo-ALOHA system can be realized by controlling a waiting time.

After transmitting the Request signal, the terminal transits to reception waiting of the Beacon signal (S1514). If a Beacon signal is not received, the terminal transits to a waiting state (S1513) again, and waits for a reception timing of the Beacon signal of a next timing.

When the Beacon signal is received, the transmission-reception system is changed to the radio system B, and a frequency band to be used is set based on the interference signal information in the Beacon signal (S1516). A method of setting this frequency band is the same as that of the second embodiment. A Data signal is transmitted in this setting (S1517).

The terminal transits to ACK reception waiting (S1518), and waits for reception of the ACK signal. If the ACK signal is not received for a predetermined time, the terminal transits to a waiting state again (S1513) and waits for a reception timing of the Beacon signal of a next timing. In this step, the transmission-reception system is returned to the radio system A (S1520).

When the ACK signal is received, the terminal transits to waiting (S1511) waiting for a timing of transmitting data to be transmitted in a next time. In a case of a system using no ACK signal, steps S1518 and S1519 are omitted and the terminal immediately transits to the waiting (S1511) waiting for a timing of transmission.

In the waiting (S1511, S1513) of the terminal described above, power sources of the transmission unit 0111 and the reception unit 0112 are shut down.

Examples of states of the base station and the terminal and a data flow realized by the abovementioned flow charts are shown in FIG. 16.

In the radio system described above, radio systems using different frequency bands are preferably adopted as the radio system A and the radio system B. A radio system having no system interfering thereto is set to the radio system A, and a radio system having possibilities of being interfered is set to the radio system B.

For example, in a case where a narrow-band radio system represented by IEEE 802.15.4 is adopted as the radio system A and UWB is adopted as the radio system B, if other interfering radio systems exist, a band thereof is avoided in transmission-reception. In this configuration, a reception waiting time of the terminal can reduced and power consumption can be reduced.

In the radio communication system described above, although the interference reduction function of being capable of sharing a frequency with other radio systems is provided, a complex structure is not required for the terminal and a cost for the system can be reduced. The terminal-initiated random access can be performed, and as a result, power consumption can be reduced.

What is claimed is:

1. A radio communication system comprising a base station and a plurality of terminals having radio transmission-reception functions,
wherein the base station has a function of transmitting a beacon signal and performs interference signal detection for detecting interference signals in frequency bands used for data transmission from the terminals to the base station before transmitting the beacon signal, and
wherein each of the terminals is transited from a waiting state of stopping a radio reception function to a reception waiting state of being capable of receiving the beacon signal before a timing of starting the data transmission, and performs the data transmission only when the beacon signal is received.

2. The radio communication system according to claim 1,
wherein the base station transmits, based on a result of the interference signal detection, the beacon signal when no interference signal is detected, and stops transmission of the beacon signal when the interference signals are detected, and repeats operation of the interference signal detection after a predetermined time elapses.

3. The radio communication system according to claim 1,
wherein an interference signal detection function of the base station detects existence and nonexistence of the interference signals and frequency bands of the interference signals, and
wherein the base station adds the existence and nonexistence of the interference signals and the frequency bands of the interference signals to the beacon signal, and transmits the beacon signal.

4. The radio communication system according to claim 3,
wherein the terminals receive the beacon signal including information of the existence and nonexistence of the interference signals and information of the frequency bands of the interference signals, and perform the data transmission using radio signals avoiding the frequency bands based on the information.

5. The radio communication system according to claim 4,
wherein transmission functions of the terminals are functions of being capable of performing transmission of radio systems of Orthogonal Frequency Division Multiplexing (OFDM) systems,
wherein the radio signals avoiding the frequency bands of the interference signals are achieved by assigning no information bit to subcarriers of OFDM signals corresponding to the frequency bands of the interference signals, and
wherein the base station has a function of receiving data signals transmitted by the radio signals.

6. The radio communication system according to claim 4,
wherein transmission functions of the terminals operate by radio systems having a plurality of frequency channels,
wherein the radio signals avoiding the frequency bands of the interference signals are achieved by selecting frequency channels including no frequency band of the interference signals, and
wherein the base station has a function of being capable of receiving a signal at all frequency channels of the radio systems and receives data signals transmitted by the radio signals of the selected frequency channel.

7. The radio communication system according to claim 1,
wherein the terminals perform the data transmission at a random time elapsed after the beacon signal is received.

8. The radio communication system according to claim 7,
wherein the random time is represented by M×Tslot, where the Tslot is a unit time, a variable M is a random integer being 0 or more and smaller than MAX, and the MAX is a positive integer.

9. The radio communication system according to claim 1,
wherein the terminals have carrier sense functions of detecting other radio signals transmitted from one of other terminals or other base stations in the radio communication system, and
wherein the terminals perform carrier sense at a random time elapsed after the beacon signal is received, and perform the data transmission if no other radio signal is detected.

10. The radio communication system according to claim 9,
wherein the random time is represented by M×Tcs, where the Tcs is a unit time, a variable M is a random integer being 0 or more and smaller than MAX, and the MAX is a positive integer, and only when M=0, the data transmission is performed without performing the carrier sense.

11. The radio communication system according to claim 1,
wherein a transmission function of the base station and reception functions of the terminals perform transmission and reception of a first radio system, respectively, and
wherein transmission functions of the terminals and a reception function of the base station perform transmission and reception of a second radio system different from the first radio system, respectively.

12. The radio communication system according to claim 11,
wherein the first radio system is a narrow-band radio system, and
wherein the second radio system is a UWB (Ultra-Wideband) system.

13. The radio communication system according to claim 1,
wherein a radio transmission function of the base station includes transmission functions of a first radio system and a second radio system,
wherein a radio reception function of the base station includes reception functions of the first radio system and the second radio system,
wherein radio transmission functions of the terminals include transmission functions of the first radio system and the second radio system,
wherein radio reception functions of the terminals include reception functions of the first radio system and the second radio system,
wherein an interference signal detection function detects existence and nonexistence of the interference signals in frequency bands used in the second radio system, adds a result of detection to the beacon signal and transmits the beacon signal by the first radio system,
wherein the terminals receive the beacon signal, check the result of detection, perform the data signal transmission by the second radio system if no interference signal exists, and perform the data signal transmission by the first radio system if the interference signals exist, and
wherein the base station receives a data signal transmitted by the selected radio system.

14. The radio communication system according to claim 13,
wherein the first radio system is a narrow-band radio system, and
wherein the second radio system is a UWB (Ultra-Wideband) system.

15. A radio communication system comprising a base station and a plurality of terminals having radio transmission-reception functions,
wherein a radio transmission function of the base station includes transmission functions of a first radio system and a second radio system,
wherein a radio reception function of the base station includes reception functions of the first radio system and the second radio system,
wherein radio transmission functions of the terminals include transmission functions of the first radio system and the second radio system,
wherein radio reception functions of the terminals include reception functions of the first radio system and the second radio system,
wherein the terminals transmit request signals by the first radio system,
wherein the base station receives the request signals, performs interference signal detection for detecting an interference signal in a frequency band used in the second radio system and transmits a beacon signal including information of existence and nonexistence of the interference signal and frequency band, and
wherein the terminals receive the beacon signal and perform data transmission using radio signals of the second radio system avoiding a frequency band based on the frequency band information.

16. The radio communication system according to claim 15,
wherein the second radio system is an Orthogonal Frequency Division Multiplexing (OFDM) system, and
wherein a function of generating the radio signals avoiding the frequency band of the interference signal is realized by assigning no information bit to a subcarrier of an OFDM signal corresponding to the frequency band of the interference signal.

17. The radio communication system according to claim 15,
wherein the second radio system is a radio system having a plurality of frequency channels, and
wherein a function of generating the radio signals avoiding the frequency band of the interference signal is realized by selecting a frequency channel different from a frequency channel corresponding to the frequency band of the interference signal.

18. The radio communication system according to claim 15,
wherein the first radio system is a narrow-band radio system, and
wherein the second radio system is a UWB (Ultra-Wideband) system.

19. The radio communication system according to claim 15,
wherein a wired transmission is used instead of the first radio system.

20. A radio communication method established between a base station and a plurality of terminals, comprising the steps of:
transmitting a beacon signal at the base station;
detecting an interference signal in a frequency band used for radio communication from the terminals to the base station before the step of transmitting the beacon signal;
causing the terminals to shift from a waiting state to beacon signal reception waiting before a timing of transmitting data; and
transmitting the data only when the beacon signal is received.
